(19) United States
(12) Patent Application Publication
(10) Pub. No.: US 2023/0078032 A1
(43) Pub. Date: Mar. 16, 2023

(54) NON-ROTATION AD HOC DISPLAY ASSEMBLY FOR WHEEL OF VEHICLE

(71) Applicant: BossWell Korea Inc., Seoul (KR)

(72) Inventors: Wonwoo LEE, Seoul (KR); Yongseok MOON, Incheon (KR)

(73) Assignee: BossWell Korea Inc., Seoul (KR)

(21) Appl. No.: 17/471,562

(22) Filed: Sep. 10, 2021

(51) Int. Cl. B60B 7/00; B60B 7/20

(52) U.S. Cl. CPC B60B 7/0053; B60B 7/0013; B60B 7/20; B60B 2900/572; B60B 2310/3025; B60B 2310/316; B60B 2310/318

(57) ABSTRACT

Provided is a non-rotational advertisement member assembly for being mounted on a wheel of a vehicle which includes: a connecting body mediating coupling to a wheel of a vehicle, and rotated interlocked using the rotation axis of the wheel as a coaxial axis; a transparent housing forming a predetermined floating space between itself and the connecting body as well as rotated interlocked with the connecting body by being coupled to the connecting body so as to completely seal the gap between the predetermined floating space and an external space; and an advertisement member floating part having a center of gravity formed relatively lower in the predetermined floating space, and rotated relatively to the transparent housing and the connecting body which are rotated interlocked with the wheel while being coupled so as to avoid rotation and movement while maintaining the center of gravity.

### TECHNICAL FIELD

The present invention relates to a non-rotational advertisement member assembly for being mounted on a wheel of a vehicle, and more particularly, to a non-rotational advertisement member assembly for being mounted on a wheel of a vehicle, in which the advertisement member installed on the wheel of the vehicle (e.g., the emblem of the vehicle manufacturer) is not rotating regardless of whether the vehicle is stopped or running and is positioned in the regular position and always exposed without shaking to the outside.

### BACKGROUND

In general, the wheels of a vehicle constitute wheels on opposite sides of the vehicle body, and are formed such that tires are mounted on the wheels. Here, as for the wheel on which the tire is mounted, in general, a stainless steel wheel and an aluminum wheel are predominant. Meanwhile, the emblem of the vehicle manufacturer is provided outside the center of the wheel to enhance the marketing effect of the vehicle manufacturer.

However, a conventional advertisement member (e.g., a vehicle manufacturer's emblem, etc.) is provided to rotate interlocked with a rotating wheel while the vehicle is driving, and it is not easy to observe from the outside while the vehicle is driving, so the marketing effect may be greatly decreased.

In order to prevent such a decrease in the marketing exhibition effect, recently, a non-rotating structure configured so that the emblem is not rotated regardless of the rotation of the wheel according to the driving of the vehicle is disclosed in Korean Patent Registration No. 10-0440295 (The Patent Registration Gazette is published on 2004 Jul. 5).

However, in the recently disclosed advertisement member (emblem) non-rotating structure of the prior patent, there is a serious problem in that the function of the product may disappear or the lifespan of the product may be shortened since foreign substances (for example, rainwater, snow, dust, mud, etc.) may be introduced into the interior through the gap between the wheel cap rotating unit 23 and the wheel cap fixing unit 21.

The above information disclosed in this Background section is only for enhancement of understanding of the background of the invention and it may therefore contain information that does not form the prior art that is already known to a person of ordinary skill in the art.

### RELATED ART DOCUMENT

### Patent Document

KR Registered Patent No. 10-0440295 (The Patent Registration Gazette is published on 2004 Jul. 5.)

### SUMMARY

### Technical Problem

One aspect of the present invention is directed to providing a non-rotational advertisement member assembly such as an emblem mounted on a wheel of a vehicle capable of preventing foreign substances from being introduced into a floating space provided with an advertisement member floating part.

In addition, another aspect of the present invention is directed to providing a non-rotational advertisement member assembly for being mounted on a wheel of a vehicle, in which the advertisement member floating part in the floating space is not rotated and fluctuated regardless of the interlocking rotation of the wheel of the vehicle.

The technical problems of the present invention are not limited to the problems mentioned above, and other technical problems not mentioned will be clearly understood by those of ordinary skill in the art from the following description.

### Technical Solution

The present invention relates to a non-rotational advertisement member assembly for being mounted on a wheel of a vehicle. More specifically, the non-rotational advertisement member assembly includes: a connecting body mediating coupling to a wheel of a vehicle, and rotated interlocked using the rotation axis of the wheel as the same axis; a transparent housing forming a predetermined floating space between itself and the connecting body as well as rotated interlocked with the connecting body by being coupled to the connecting body so as to completely seal the gap between the predetermined floating space and an external space; and an advertisement member floating part having a center of gravity formed relatively below in the predetermined floating space, and rotated relatively to the transparent housing and the connecting body which are rotated interlocked with the wheel while being coupled so as to avoid rotation and movement while maintaining the center of gravity. Therefore, the non-rotational advertisement member assembly is capable of stably protecting the advertisement member floating part from the outside as well as preventing the malfunction of a product by preventing the inflow of foreign substances from the outside to the inside, and lowering manufacturing costs by minimizing the number of components and combination processes.

Here, a coupling portion where a front end of the connecting body and a rear end of the transparent housing are in contact may be coupled by an ultrasonic welding coupling method.

In addition, a welding groove ring formed to be concave along the circumferential direction of the transparent housing may be formed at the front end of the connecting body, a coupling rib protruding to be inserted into the welding groove ring may be formed at the rear end of the transparent housing, and a welding rib that is to be melted by an ultrasonic welding machine may be provided to protrude at the fore-end of the coupling rib.

In addition, non-rotational advertisement member assembly may further include a decorative housing hooked and fixed to an edge end of the connecting body while enclosing a part of the front edge and all of the side edge of the transparent housing, wherein in the case of the transparent housing, at least a portion exposed to the outside of the decorative housing is made of a transparent material.

In addition, the advertisement member floating part may include an advertisement member panel on which an advertisement member of a wheel of a vehicle is embossed or engraved; a holder portion coupled to the connecting body so that the advertisement member panel is face-attached to the front surface and is rotatably supported in the predetermined floating space; and a center of gravity weight coupled to the rear surface of the holder portion to form a center of gravity of the holder portion at a relatively lower side of the predetermined floating space.

In addition, the holder portion and the connecting body may be coupled to each other via a rotation support bearing portion.

In addition, the rotation support bearing portion may include an inner ring portion having a bearing through-hole through which the center is penetrated back and forth; and an outer ring portion disposed to surround the outer circumference surface of the inner ring portion, wherein the outer ring portion is fitted and fixed to an annular outer ring-side bearing installation rib formed to protrude forward from the front surface of the connecting body, and a bearing through-hole of the inner ring portion is fitted and fixed to the outside of an annular inner ring-side bearing installation rib formed to protrude rearward from the rear surface of the holder portion.

In addition, the inner ring portion and the outer ring portion of the rotation support bearing portion may be detachably coupled by applying a hook with respect to the connecting body and the holder portion, respectively.

In addition, the advertisement member floating part may further include an adhesive sheet disposed between the advertisement member panel and the holder portion to face-attach the advertisement member panel to the front surface of the holder portion.

In addition, the decorative housing may include an inclined ring portion having a vertical cross-section in which the front end is inclined at a predetermined angle toward the front; and a coupling ring portion extended rearward from the rear end of the inclined ring portion and having a plurality of hook protrusion panels formed in the circumferential direction so as to be hook-coupled to the connecting body.

In addition, a coupling portion of the connecting body and the transparent housing may be hidden inside a coupling groove formed in the center of the wheel and not exposed to the outside.

In addition, the front end of the transparent housing may be spaced apart by a predetermined distance forward with respect to the front surface of the advertisement member floating part to form the floating space.

In addition, the connecting body and the transparent housing may be formed in a circular shape, and the coupling portion may be set at a position having at least an outer diameter greater than an outer diameter of the front edge of the transparent housing.

In addition, a stepped portion having an outer diameter corresponding to the coupling portion may be formed at the rear end of the transparent housing corresponding to the coupling portion, and an ultrasonic welding machine for ultrasonically welding the transparent housing and the connecting body may be in contact with the outer surface of the stepped portion.

### Advantageous Effects

According to an embodiment of the non-rotational advertisement member assembly for being mounted on a wheel of a vehicle according to the present invention, various effects can be achieved.

First, since the connecting body and the transparent housing are coupled to each other by an ultrasonic welding coupling method to completely seal the external space and the floating space (in which the advertisement member floating part is located) between the connecting body and the transparent housing, thereby preventing the inflow of foreign substances from the outside, the present invention can ensure the maximum life of the rotation support bearing portion together with the non-rotation function of the advertisement member.

Second, by providing a transparent housing for protecting the advertisement member, it is possible to prevent the advertisement member from being contaminated or damaged.

Third, the advertisement member floating part is provided so as not to rotate or fluctuate in the floating space between the connecting body and the transparent housing that are rotated interlocked with a wheel of a vehicle, thereby increasing the marketing effect of the advertisement member mounted on the wheel when the vehicle is stopped and driven.

Fourth, it is possible to reduce the overall number of parts by minimizing the number of assembly parts, and it is possible to reduce the production and manufacturing cost when mass-producing the product, so that it is possible to facilitate the supply to the consumer.

### BRIEF DESCRIPTION OF THE DRAWINGS

The above and other aspects, features, and advantages of the present invention will become more apparent to those of ordinary skill in the art by describing embodiments thereof in detail with reference to the accompanying drawings, in which:

FIG. 1 is a side view and a perspective view of a non-rotational advertisement member assembly for being mounted on a wheel of a vehicle according to an exemplary embodiment of the present invention, which is mounted on a vehicle;

FIGS. 2A and 2B are an exploded perspective view of a front part and an exploded perspective view of a rear part of a non-rotational advertisement member assembly for being mounted on a wheel of a vehicle according to an exemplary embodiment of the present invention;

FIGS. 3A and 3B are a cross-sectional view and a cut-away perspective view, taken along line A-A of FIG. 1;

FIG. 4 is a cut-away perspective view taken along line B-B of FIG. 3B;

FIG. 5 is a cut-away exploded perspective view and enlarged views for explaining an ultrasonic welding portion of a connecting body and a transparent housing in the configuration of an embodiment of a non-rotational advertisement member assembly for being mounted on a wheel of a vehicle according to the present invention;

FIG. 6 is an exploded perspective view for explaining the positional relationship of the advertisement member floating part with respect to the connecting body of FIG. 5;

FIGS. 7A to 7D are exploded perspective views for explaining the assembly process of the advertisement member floating part in the configuration of FIG. 1;

FIGS. 8 and 9 are exploded perspective views for explaining the coupling process of a transparent housing and a decorative housing with respect to the connecting body.

### DETAILED DESCRIPTION OF THE EMBODIMENTS

Hereinafter, an embodiment of a non-rotational advertisement member assembly for being mounted on a wheel of a vehicle according to the present invention will be described in detail with reference to the accompanying drawings.

In adding reference numerals to the elements of each drawing, it should be noted that the same elements are given the same reference numerals as much as possible even though they are indicated on different drawings. In addition, in describing the embodiment of the present invention, when it is determined that a detailed description of a related known configuration or function interferes with the understanding of the embodiment of the present invention, the detailed description thereof will be omitted.

In describing the elements of the embodiment of the present invention, terms such as first, second, A, B, (a), (b), etc. may be used. These terms are only for distinguishing the elements from other elements, and the essence, sequence, or order of the elements are not limited by the terms. In addition, unless otherwise defined, all terms used herein, including technical or scientific terms, have the same meaning as commonly understood by one of ordinary skill in the art. Terms such as those defined in a commonly used dictionary should be interpreted as having a meaning consistent with the meaning in the context of the related art, and should not be interpreted in an ideal or excessively formal meaning unless explicitly defined in the present application.

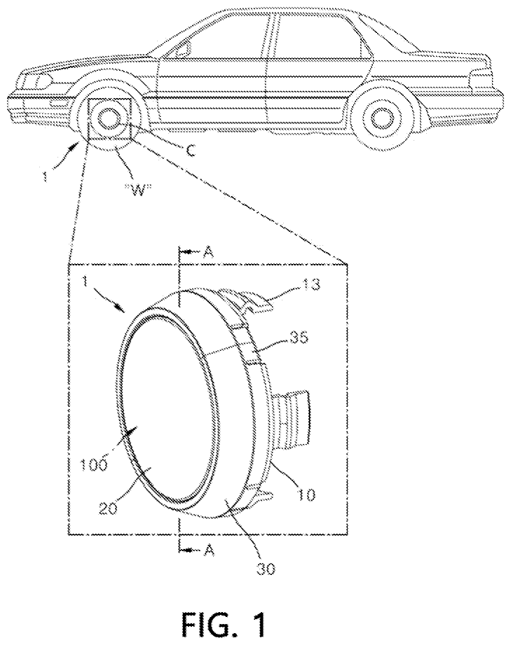

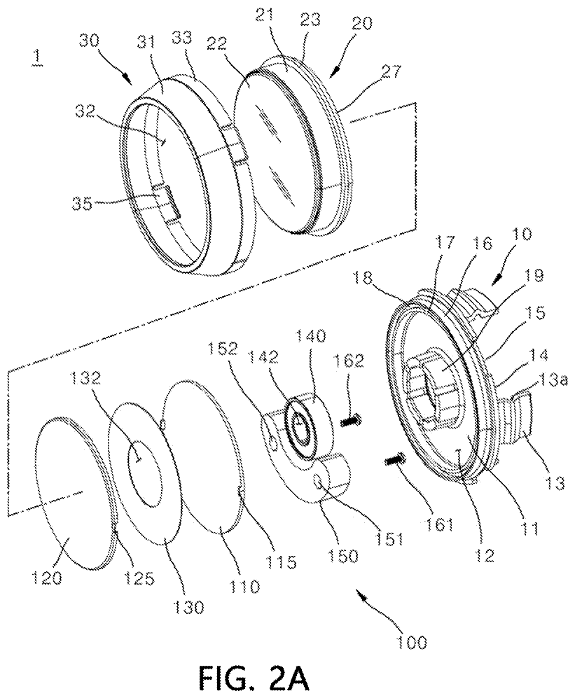

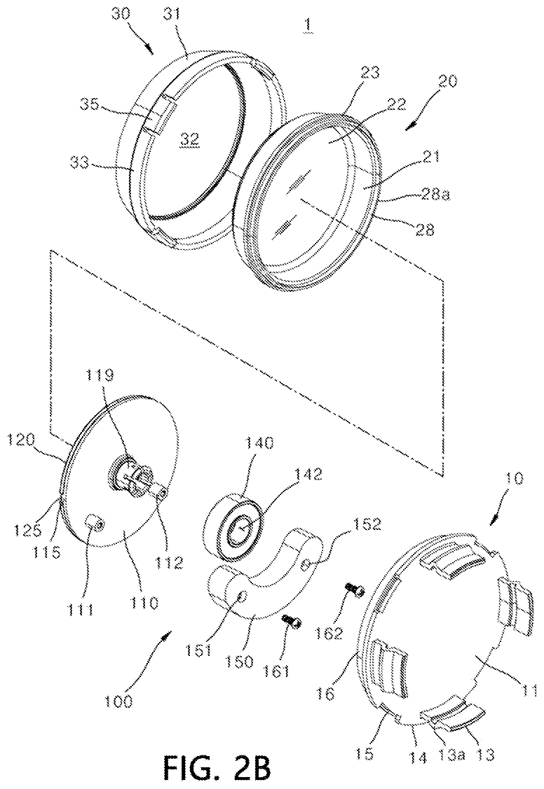

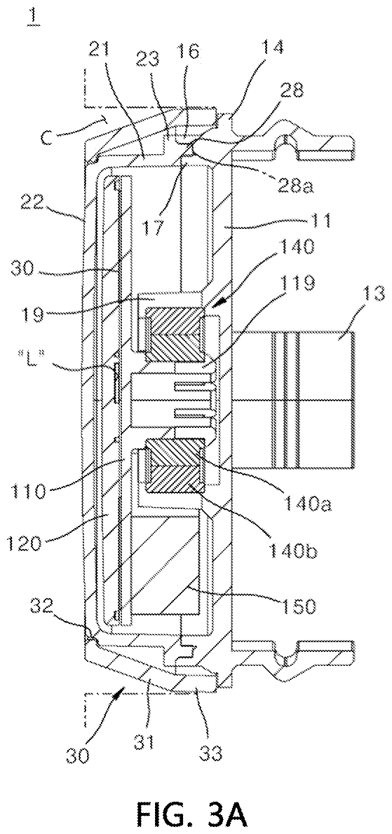

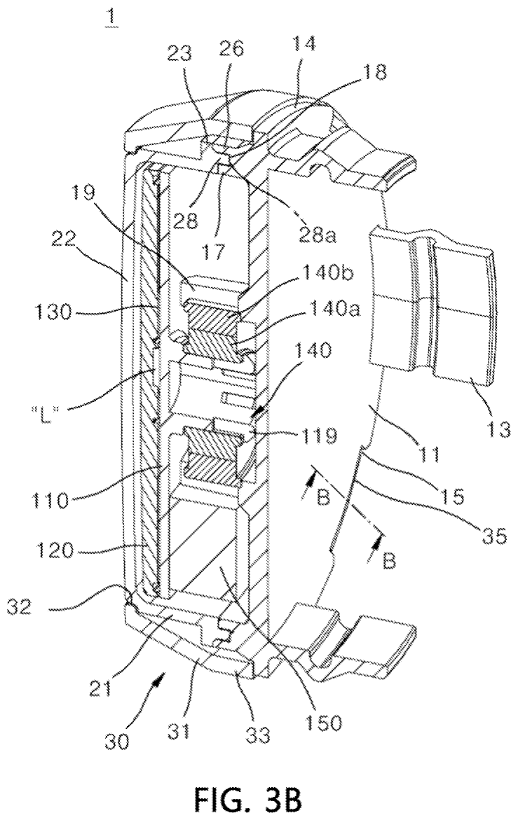

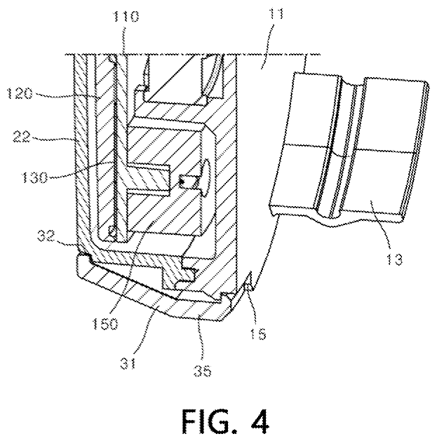

FIG. 1 is a side view and a perspective view of a non-rotational advertisement member assembly for being mounted on a wheel of a vehicle according to an exemplary embodiment of the present invention, which is mounted on a vehicle; FIGS. 2A and 2B are an exploded perspective view of a front part and an exploded perspective view of a rear part of a non-rotating wheel cap for displaying an emblem of a vehicle according to the present invention; FIGS. 3A and 3B are a cross-sectional view and a cut-away perspective view, taken along line A-A of FIG. 1; and FIG. 4 is a cut-away perspective view taken along line B-B of FIG. 3B.

An embodiment 1 of a non-rotational advertisement member assembly for being mounted on a wheel of a vehicle according to the present invention, as shown in FIGS. 1 to 3B, includes a connecting body 10 that mediates the coupling to a wheel W of a vehicle, a transparent housing 20 coupled to form a predetermined floating space between the connecting body 10, and an advertisement member floating part 100 located in the predetermined floating space.

Here, as shown in FIG. 1, the connecting body 10 may be detachably coupled to the coupling portion C formed to be recessed in the center of the wheel W of the vehicle. The coupling portion C may be formed in a circular shape to be concave inside the wheel W, and the connecting body 10 may be fixed to the inner side edge of the coupling portion C.

More specifically, as shown in FIGS. 2A to 3B, the connecting body 10 may include a body plate 11, a plurality of latching legs 13 formed to protrude rearward from the rear surface of the body plate 11, welding groove rings 16 and 17 that are formed to protrude a predetermined length forward along the edge of the body plate 11 so as to form a part of the floating space 12 in the front of the body plate 11, and an outer ring-side bearing installation rib 19 protruding forward from the center of the front surface of the body plate 11 to combine a rotation support bearing portion 140 among the configuration of the advertisement member floating part 100 to be described later.

The connecting body 10 may be fixed to the wheel W of the vehicle, and may be rotated interlocked using the rotation axis of the wheel W as a coaxial axis when the wheel W is rotated while the vehicle is running. Therefore, when the vehicle is driving forward, when the wheel W rotates counterclockwise in the drawing of FIG. 1, the connecting body 10 may also rotate counterclockwise, and when the vehicle is driving backward, when the wheel W rotates clockwise in the drawing of FIG. 1, the connecting body 10 may also rotate clockwise.

The body plate 11 of the connecting body 10 may be formed in a approximately disk shape, and on the edge end 14, a plurality of hook latching grooves 15 for hooking and fixing of the decorative housing 30 to be described later may be cut and formed so as to be spaced apart by a predetermined distance in the circumferential direction.

The plurality of latching legs 13 may be provided to be spaced apart a predetermined distance in the circumferential direction along the rear edge end of the body plate 11; and hook protrusions 13a protruding outward, respectively and hook-coupled to the inner surface of the coupling portion C of the wheel W may be formed in the middle portion of the plurality of latching legs 13.

The welding groove rings 16 and 17 may be formed to protrude in a ring shape at a predetermined distance from the front surface of the edge end 14 of the body plate 11, wherein a welding groove 18 is provided between the outer groove ring 16 having a relatively large diameter and the inner groove ring 17 having a relatively smaller diameter than the outer groove ring 16. That is, the welding groove 18 is formed in a circular groove shape recessed backward between the outer groove ring 16 and the inner groove ring 17 constituting the welding groove rings 16 and 17 of the body plate 11. The vertical cross-sectional shape of the welding groove 18 may be formed to have a approximately rectangular shape with an open front.

Meanwhile, as shown in FIGS. 2A to 3B, the transparent housing 20 may form the above-described predetermined floating space 12 between the connecting body 10 and also be coupled to the connecting body 10 to completely seal between the predetermined floating space 12 and the external space. As such, the transparent housing 20 may be coupled to the connecting body 10 to rotate interlocked.

More specifically, as shown in FIGS. 2A to 3B, the transparent housing 20 may be formed in a ring shape, and may include a side wall portion 21 having a front and rear width to form the above-described predetermined floating space 12 between the connecting body 10; a see-through window 22 for projecting the logo L of an advertisement member panel 120 out of the configuration of the advertisement member floating part 100 to be described later as a disk-shaped plate provided to connect the front ends of the side wall portion 21, to the outside; and a coupling rib 28 projecting a predetermined length backward from the rear surface of the stepped portion 23 formed to be larger than the outer diameter of the rear end of the side wall portion 21, and inserted into the welding groove 18 of the welding groove rings 16 and 17 of the connecting body 10. As shown in FIGS. 3A and 3B, at the fore-end of the coupling rib 28, a welding rib 28a that is to be melted by an ultrasonic welding machine (not shown) to be described later may be provided to protrude in a wedge shape.

Here, as shown in FIGS. 3A and 3B, in the case of the connecting body 10 and the transparent housing 20, a coupling portion where the front end of the connecting body 10 and the rear end of the transparent housing 20 are in contact may be coupled by any one of a bonding method using a bonding material and an ultrasonic welding coupling method using an ultrasonic welding machine. However, since there is an additional problem in that the bonding method is not easy to completely seal the connection between the connecting body 10 and the transparent housing 20, which is the original purpose, and the bonding time and manufacturing cost increase because a separate drying time is required after the bonding material is applied, it is preferable to adopt an ultrasonic welding coupling method.

The coupling portion where ultrasonic welding is performed may be defined as a portion where the welding groove 18 of the welding groove rings 16 and 17 formed in the connecting body 10 and the coupling rib 28 formed in the transparent housing 20 contact each other.

As shown in FIGS. 1 to 3B, the transparent housing 20 may be provided as a wheel cap having a shape that is relatively smaller than the size of the wheel W, as well as it may be provided as a wheel cover in the form of surrounding most of the outer surface of the wheel W. Even in this case, if the transparent housing 20 has a structure that can be rotated interlocked with the rotation of the wheel W, and can form a floating space 12 between the connecting body 10 as described above, regardless of the name, any configuration will be included in the transparent housing 20 of the present embodiment.

Meanwhile, as shown in FIG. 3A, the coupling portion of the connecting body 10 and the transparent housing 20 may be provided at a position hidden inside the coupling portion C of the wheel W, be provided so as not to be observed from the outside by being covered by the decorative housing 30 to be described later, and also be provided to completely seal the predetermined floating space 12 and the external space through an ultrasonic welding coupling method.

As shown in FIG. 2B, of the configuration of the transparent housing 20, except for the see-through window 22, the remaining portions (the side wall portion 21, the stepped portion 23, and the coupling rib 28) may be not exposed to the outside, thereby preventing deterioration of the aesthetic appearance. That is, the see-through window 22 constituting the front end of the transparent housing 20 may be provided to be spaced apart by a predetermined distance forward with respect to the front surface of the advertisement member floating part 100 (that is, the front surface of the advertisement member panel 120 to be described later) to form the floating space 12, thereby capable of effectively protecting the advertisement member floating part 100 from the outside.

Here, among the configuration of the transparent housing 20, at least the see-through window 22, which is a portion exposed to the outside of the decorative housing 30, may be made of a transparent material, so that the logo L of the emblem floating part 100 located in the front part of the predetermined floating space 12 can be easily projected through the outside.

Meanwhile, as shown in FIGS. 2A and 2B, the embodiment of a non-rotational advertisement member assembly for being mounted on a wheel of a vehicle according to the present invention may further include a decorative housing 30 that is hooked and fixed to the edge end 14 of the connecting body 10 while enclosing a part of the front edge and all of the side edge (that is, the entire side wall portion 21) of the transparent housing 20.

As described above, decorative housing 30 may serve to prevent the elements corresponding to the inner portion of the transparent housing 20 from being exposed to the outside, and at the same time, to foreign substances such as rainwater, snow, dust, mud, etc. from being introduced into the coupling portion C of the wheel W.

To this end, as shown in FIGS. 2A and 3A, the decorative housing 30 may include an inclined ring portion 31 having a vertical cross-section in which the front end is inclined at a predetermined angle toward the front, and a coupling ring portion 33 extended rearward from the rear end of the inclined ring portion 31 and having a plurality of hook protrusion panels 35 formed in the circumferential direction so as to be hook-coupled to the connecting body 10.

As shown in FIG. 4, the decorative housing 30 may expose the see-through window 22 of the transparent housing 20 to the outside through the through-hole 32 provided to penetrate in the front-rear direction. In the case of the front end of the through-hole 32 of the decorative housing 30, the front may be latch-coupled to a stepped portion formed outside the front end of the see-through window 22 of the transparent housing 20 so as to match the front of the see-through window 22, and in the case of the rear end of the decorative housing 30, the above-described hook protrusion panel 35 may be latch-coupled to the hook latching groove 15 formed in the edge end 14 of the connecting body 10.

Here, as shown in FIG. 3a, the inclined ring portion 31 of the decorative housing 30 may be formed to be inclined toward the center of the see-through window 22 of the transparent housing 20, thereby preventing foreign substances such as rainwater falling from the upper side of the coupling portion C of the wheel W from flowing into the coupling portion C.

However, in the embodiment 1 of a non-rotational advertisement member assembly for being mounted on a wheel of a vehicle according to the present invention, the decorative housing 30 is not necessarily provided. That is, the front edge of the transparent housing 20 can be changed and designed to perform the same function as the decorative housing 30, and it is also possible to use only the transparent housing 20 to expose the advertisement member panel 120 therein, depending on the size and position of the displayed advertisement member.

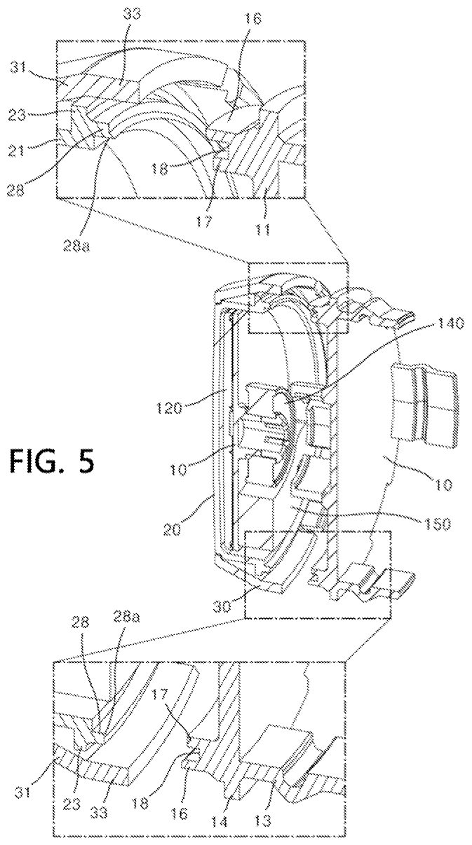

FIG. 5 is a cut-away exploded perspective view and enlarged views for explaining an ultrasonic welding portion of a connecting body and a transparent housing in the configuration of an embodiment of a non-rotational advertisement member assembly for being mounted on a wheel of a vehicle according to the present invention.

In an embodiment 1 of a non-rotational advertisement member assembly for being mounted on a wheel of a vehicle according to the present invention, as shown in FIG. 5, the connecting body 10 and the transparent housing 20 may be coupled to be completely sealed to each other through an ultrasonic welding coupling method.

More specifically, as shown in each enlarged view of FIG. 5, an outer groove ring 16 and an inner groove ring 17 may be formed respectively at the front end of the connecting body 10 to protrude forward, and a coupling rib 28 formed at the rear end of the transparent housing 20 may be inserted between the outer groove ring 16 and the inner groove ring 17. In addition, as shown in the enlarged views of FIG. 5, the coupling rib 28 may be formed at the rear end of the transparent housing 20 to protrude rearward, and the coupling rib 28 may be inserted into a welding groove 18 of the connecting body 10 together with a welding rib 28a provided at the fore-end thereof and then welded to each other by an ultrasonic welding machine (not shown) in an ultrasonic welding coupling method.

Here, a stepped portion 23 having an outer diameter corresponding to the coupling portion may be formed at the rear end corresponding to the above-mentioned coupling portion in the configuration of the transparent housing 20, and an ultrasonic welding machine for ultrasonically welding the transparent housing 20 and the connecting body 10 may be in contact with the outer surface of the stepped portion 23.

That is, in a state in which the coupling rib 28 of the transparent housing 20 is inserted into the welding groove 18 of the connecting body 10, when the ultrasonic welding machine is in contact with the front surface formed by the stepped portion 23 and applies ultrasonic vibration, the welding rib 28a provided to protrude in a wedge shape at the fore-end of the coupling rib 28 may be melted and filled in the welding groove 18 of the connecting body 10 to combine the connecting body 10 and the transparent housing 20 each other. The transparent housing 20 is preferably made of a thermoplastic resin material to facilitate ultrasonic welding coupling by an ultrasonic welding machine.

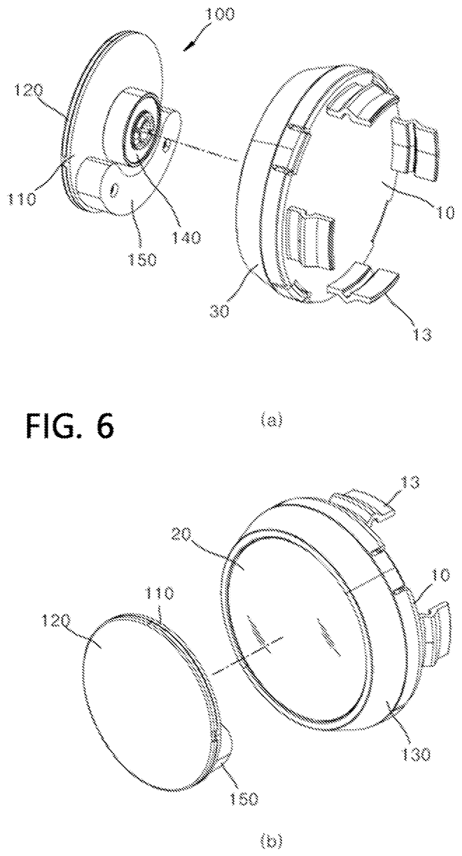

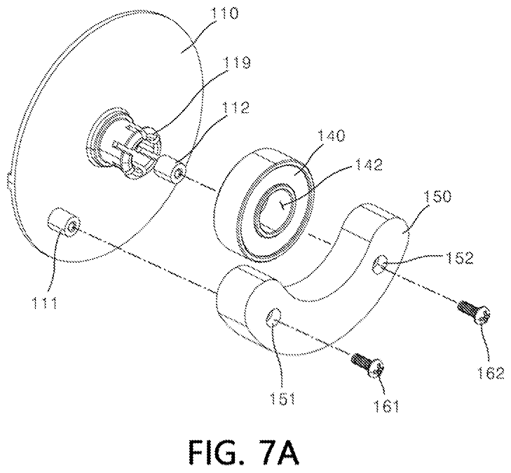

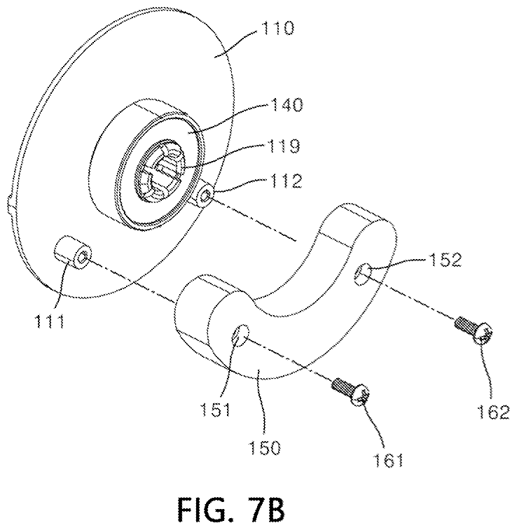

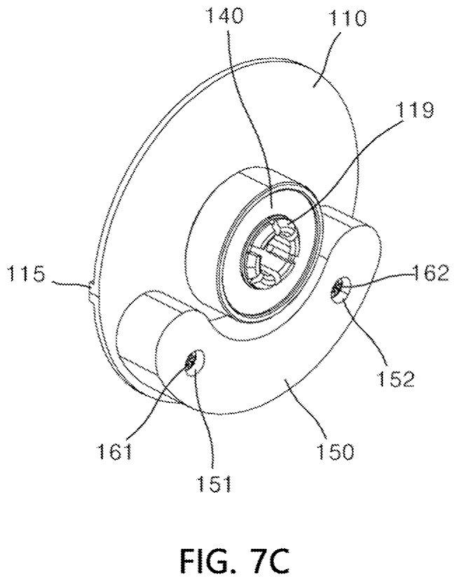

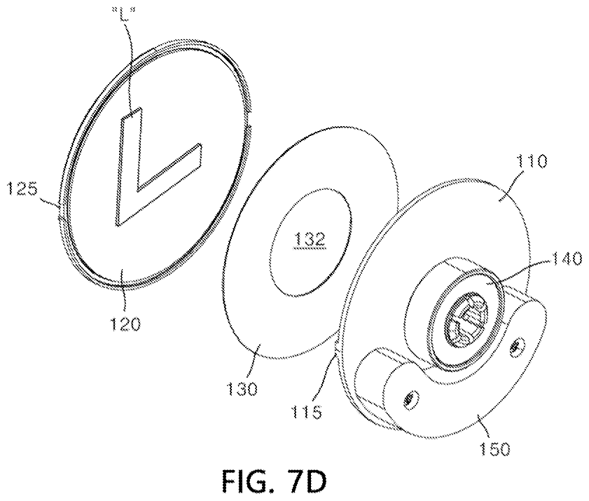

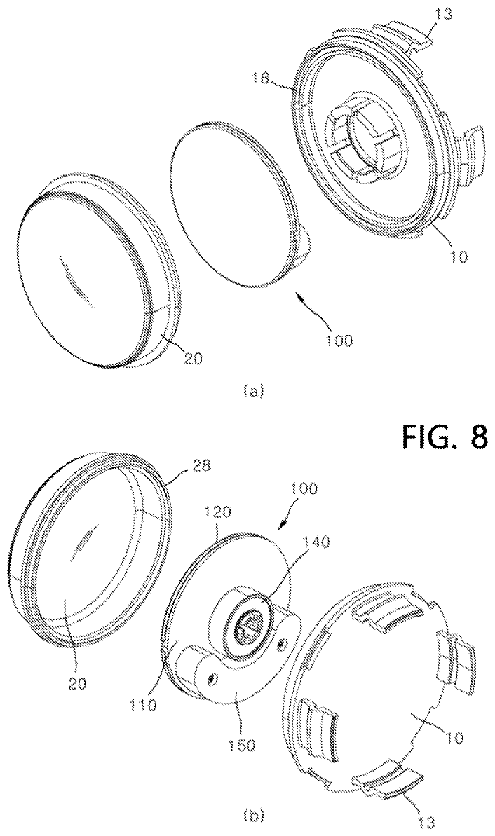

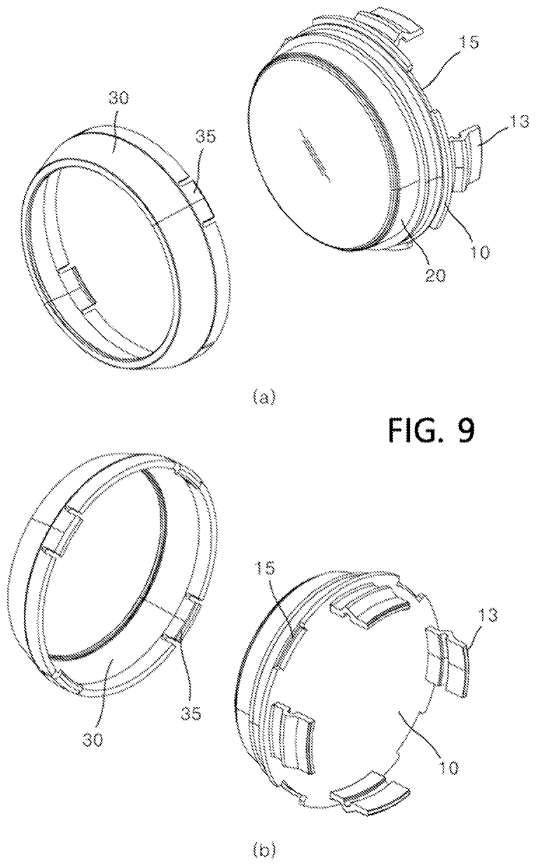

FIG. 6 is an exploded perspective view for explaining the positional relationship of the advertisement member floating part with respect to the connecting body of FIG. 5; FIGS. 7A to 7D are exploded perspective views for explaining the assembly process of the advertisement member floating part in the configuration of FIG. 1; and FIGS. 8 and 9 are exploded perspective views for explaining the coupling process of a transparent housing and a decorative housing with respect to the connecting body.

In an embodiment 1 of a non-rotational advertisement member assembly for being mounted on a wheel of a vehicle according to the present invention, as shown in FIGS. 6 to 9, the advertisement member floating part 100 may be coupled so as not to rotate and fluctuate while maintaining a predetermined center of gravity regardless of the rotation of the wheel W of the vehicle or the above-described connecting body 10 and the transparent housing 20 in a predetermined floating space 12 formed by the connecting body 10 and the transparent housing 20.

As shown in FIGS. 6 to 7D, the advertisement member floating part 100 may include an advertisement member panel 120 on which an advertisement member (for example, an emblem of a vehicle manufacturer, hereinafter collectively referred to as ‘logo’, and integrated with reference number “L”) for being mounted on a wheel of a vehicle is embossed or engraved; a holder portion 110 coupled to the connecting body 10 so that the advertisement member panel 120 is face-attached to the front surface and is rotatably supported in the predetermined floating space 12; and a center of gravity weight 150 coupled to the rear surface of the holder portion 110 to form a center of gravity of the holder portion 110 at a relatively lower side of the predetermined floating space 12.

In addition, the advertisement member floating part 100 may further include a rotation support bearing portion 140 that mediates the mutual coupling of the holder portion 110 and the connecting body 10.

The rotation support bearing portion 140 may serve as a mediator so that the holder portion 110 of the advertisement member floating part 100 is mutually coupled while maintaining a minimum frictional force regardless of rotation in one direction or rotation in the other direction of the connecting body 10 in the floating space 12.

As shown in FIGS. 7A to 7D, the holder portion 110 may be formed in a disk shape, wherein the front thereof is formed flat, at least one screw fastening bush 111 and 112 to which the center of gravity weight 150 is fastened and coupled through at least one coupling screw 161 and 162 is formed to protrude rearward on the left and right sides of the rear surface thereof, and an inner ring-side bearing installation rib 119 protruding backward to fix a part of the rotation support bearing portion 140 is formed in the central portion of the rear surface thereof.

Meanwhile, at both left and right ends of the holder portion 110, hook protrusions 115 for hook coupling with the advertisement member panel 120 may be formed to protrude forward by a predetermined length, respectively, and at both left and right ends of the advertisement member panel 120, hook fastening grooves 125 through which the hook protrusions 115 of the holder portion 110 are hooked and fastened may be formed, respectively.

In addition, as shown in FIG. 7D, the advertisement member floating part 100 may further include an adhesive sheet 130 disposed between the advertisement member panel 120 and the holder portion 110 to face-attach the advertisement member panel 120 to the front surface of the holder portion 110. The adhesive sheet 130 may be provided in the form of a double-sided tape in which a predetermined adhesive material is applied to the front and rear surfaces, wherein the approximate center thereof is formed in a ring shape by a through portion 132 penetrated by a predetermined size.

As shown in FIGS. 3A and 3B and FIGS. 7A to 7D, the rotation support bearing portion 140 may include an inner ring portion 140a having a bearing through-hole 142 through which the center is penetrated back and forth, and an outer ring portion 140b disposed to surround the outer circumference surface of the inner ring portion 140a. It is obvious that a plurality of bearing balls (not shown) may be interconnected by an embedded ball bearing type between the inner ring portion 140a and the outer ring portion 140b.

The rotation support bearing portion 140 may mediate the rotation support coupling of the holder portion 110 to the connecting body 10 through the following operation that the outer ring portion 140b is fitted and fixed to the annular outer ring-side bearing installation rib 19 formed to protrude forward from the front surface of the connecting body 10, and the bearing through-hole 142 of the inner ring portion 140a is fitted and fixed to the outside of the annular inner ring-side bearing installation rib 119 formed to protrude rearward from the rear surface of the holder portion 110.

As such, the rotation support bearing portion 140 can be coupled through the operation: that the outer ring portion 140b is first coupled to the outer ring-side bearing installation rib 19 of the connecting body 10 to be fitted and fixed, and then by moving the holder portion 110 to the connecting body 10 side, the inner ring-side bearing installation rib 119 of the holder portion 110 is fitted and fixed into the bearing through-hole 142 of the inner ring portion 140a; however, in contrast, as shown in FIGS. 7A to 7D, it can be also coupled through the operation: that by moving the rotation support bearing portion 140 to the rear of the holder portion 110, the inner ring-side bearing installation rib 119 is fitted and fixed through the bearing through-hole 142 of the inner ring portion 140a, and then by moving the holder portion 110 to which the center of gravity weight 150 is coupled to the front of the connecting body 10, the outer ring portion 140b is fitted and fixed to the outer ring-side bearing installation rib 19.

The inner ring-side bearing installation rib 119 and the outer ring-side bearing installation rib 19 may have their fore-ends formed in a hook shape so as to be hooked and fixed respectively with respect to the rotation support bearing portion 140.

Meanwhile, at least one screw through-hole 151 and 152 through which at least one coupling screw 161 and 162 passes respectively may be formed in the center of gravity weight 150 coupled to the rear surface of the holder portion 110.

The center of gravity weight 150 serves to keep the center of gravity of the holder portion 110 relatively lower in the floating space 12 formed between the connecting body 10 and the transparent housing 20, whereby it serves to prevent the holder portion from rotating and fluctuating in the floating space 12 regardless of the interlocked rotation of the connecting body 10 and the transparent housing 20 according to the rotation of the wheel W of the vehicle. To this end, the center of gravity weight 150 may be formed in a rounded shape that surrounds a lower portion of the rotation support bearing portion 140, as shown in FIGS. 7A to 7D.

An assembly process of the non-rotational advertisement member assembly for being mounted on a wheel of a vehicle according to the present invention configured as described above will be described with reference to the accompanying drawings (in particular, FIGS. 7A to 9).

First, as shown in FIGS. 7A and 7B, the rotation support bearing portion 140 may be fitted and fixed to the inner ring-side bearing installation rib 119 formed on the rear surface of the holder portion 110.

Next, as shown in FIGS. 7B and 7C, the center of gravity weight 150 may be coupled to the at least one screw fastening bush 111 and 112 formed on the rear surface of the holder portion 110 by sequentially passing at least one coupling screw 161 and 162 through the screw through-holes 151 and 152 formed in the center of gravity weight 150.

And, as shown in FIG. 7D, with the adhesive sheet 130 provided between the holder portion 110 and the advertisement member panel 120, the coupling of the holder portion 110 and the advertisement member panel 120 may be completed by hooking and fixing the hook protrusions 115 formed on the left and right ends of the holder portion 110 to the hook fastening grooves 125 formed on the left and right ends of the advertisement member panel 120.

In this way, when the assembly of the advertisement member floating part 100 is completed, as shown in FIG. 8, by moving the advertisement member floating part 100 to the connecting body 10 side, in addition to fixing the rotation support bearing portion 140 of the advertisement member floating part 100 to the outer ring-side bearing installation rib 19 formed on the front surface of the body plate 11, using an ultrasonic welding machine (not shown), the coupling rib 28 of the transparent housing 20 is inserted into the welding groove 18 of the connecting body 10 and coupled by an ultrasonic welding coupling method.

Finally, as shown in FIG. 9, the assembly of one embodiment 1 of the non-rotational advertisement member assembly for being mounted on a wheel of a vehicle according to the present invention may be completed when the decorative housing 30 is coupled so that the remaining portions except for the see-through window 22 of the transparent housing 20 are not exposed to the outside by hooking and fastening the hook protrusion panel 35 of the decorative housing 30 to the hook latching groove 15 of the connecting body 10.

As such, one embodiment 1 of the non-rotational advertisement member assembly for being mounted on a wheel of a vehicle according to the present invention can prevent the malfunction and ensure the life of the product by blocking the inflow of foreign substances from the outside, by coupling to completely seal between the connecting body 10 and the transparent housing 20 through an ultrasonic welding coupling method. In addition, it can provide the advantage of obtaining an effective marketing effect since it is possible to install the advertisement member floating part 100 in the floating space 12 between the connecting body 10 and the transparent housing 20 so as not to be shaken at all regardless of the rotation of the wheel W of the vehicle.

As described above, an embodiment of a non-rotational advertisement member assembly for being mounted on a wheel of a vehicle according to the present invention has been described in detail with reference to the accompanying drawings. However, the embodiments of the present invention are not necessarily limited by the above-described embodiment, and it is natural that various modifications and implementations within an equivalent range are possible by those of ordinary skill in the art. Therefore, the true scope of the present invention will be determined by the claims to be described later.

### DESCRIPTION OF SYMBOLS

1: non-rotational advertisement member assembly
10: connecting body
18: welding groove
20: transparent housing
28: coupling rib
28a: welding rib
30: decorative housing
100: advertisement member floating part
110: holder portion
120: advertisement member panel
130: adhesive sheet
140: rotation support bearing portion
150: center of gravity weight
W: wheel
C: coupling groove
L: logo

What is claimed is:

1. A non-rotational advertisement member assembly for being mounted on a wheel of a vehicle, comprising:
a connecting body mediating coupling to a wheel of a vehicle, and rotated interlocked using the rotation axis of the wheel as a coaxial axis;
a transparent housing forming a predetermined floating space between itself and the connecting body as well as rotated interlocked with the connecting body by being coupled to the connecting body so as to completely seal the gap between the predetermined floating space and an external space; and
an advertisement member floating part having a center of gravity formed relatively lower in the predetermined floating space, and rotated relatively to the transparent housing and the connecting body which are rotated interlocked with the wheel while being coupled so as to avoid rotation and movement while maintaining the center of gravity.

2. The non-rotational advertisement member assembly for being mounted on a wheel of a vehicle of claim 1, wherein a coupling portion where a front end of the connecting body and a rear end of the transparent housing are in contact is coupled by an ultrasonic welding coupling method.

3. The non-rotational advertisement member assembly for being mounted on a wheel of a vehicle of claim 2,
wherein a welding groove ring formed to be concave along the circumferential direction of the transparent housing is formed at the front end of the connecting body,
a coupling rib protruding to be inserted into the welding groove ring is formed at the rear end of the transparent housing, and
a welding rib that is to be melted by an ultrasonic welding machine is provided to protrude at the fore-end of the coupling rib.

4. The non-rotational advertisement member assembly for being mounted on a wheel of a vehicle of claim 1, further comprising a decorative housing hooked and fixed to an edge end of the connecting body while enclosing a part of the front edge and all of the side edge of the transparent housing,
wherein in the case of the transparent housing, at least a portion exposed to the outside of the decorative housing is made of a transparent material.

5. The non-rotational advertisement member assembly for being mounted on a wheel of a vehicle of claim 1, wherein the advertisement member floating part comprises:
an advertisement member panel on which an advertisement member of a wheel of a vehicle is embossed or engraved;
a holder portion coupled to the connecting body so that the advertisement member panel is face-attached to the front surface and is rotatably supported in the predetermined floating space; and
a center of gravity weight coupled to the rear surface of the holder portion to form a center of gravity of the holder portion at a relatively lower side of the predetermined floating space.

6. The non-rotational advertisement member assembly for being mounted on a wheel of a vehicle of claim 5, wherein the holder portion and the connecting body are coupled to each other via a rotation support bearing portion.

7. The non-rotational advertisement member assembly for being mounted on a wheel of a vehicle of claim 6, wherein the rotation support bearing portion comprises:
an inner ring portion having a bearing through-hole through which the center is penetrated back and forth; and
an outer ring portion disposed to surround the outer circumference surface of the inner ring portion,
wherein the outer ring portion is fitted and fixed to an annular outer ring-side bearing installation rib formed to protrude forward from the front surface of the connecting body, and a bearing through-hole of the inner ring portion is fitted and fixed to the outside of an annular inner ring-side bearing installation rib formed to protrude rearward from the rear surface of the holder portion.

8. The non-rotational advertisement member assembly for being mounted on a wheel of a vehicle of claim 7, wherein the inner ring portion and the outer ring portion of the rotation support bearing portion are forced-fitted and coupled in a hook manner with respect to the connecting body and the holder portion, respectively.

9. The non-rotational advertisement member assembly for being mounted on a wheel of a vehicle of claim 5, wherein the advertisement member floating part further comprises an adhesive sheet disposed between the advertisement member panel and the holder portion to face-attach the advertisement member panel to the front surface of the holder portion.

10. The non-rotational advertisement member assembly for being mounted on a wheel of a vehicle of claim 4, wherein the decorative housing comprises:
an inclined ring portion having a vertical cross-section in which the front end is inclined at a predetermined angle toward the front; and
a coupling ring portion extended rearward from the rear end of the inclined ring portion and having a plurality of hook protrusion panels formed in the circumferential direction so as to be hook-coupled to the connecting body.

11. The non-rotational advertisement member assembly for being mounted on a wheel of a vehicle of claim 1, wherein a coupling portion of the connecting body and the transparent housing is hidden inside a coupling groove formed in the center of the wheel and not exposed to the outside.

12. The non-rotational advertisement member assembly for being mounted on a wheel of a vehicle of claim 11, wherein the front end of the transparent housing is spaced apart by a predetermined distance forward with respect to the front surface of the advertisement member floating part to form the floating space.

13. The non-rotational advertisement member assembly for being mounted on a wheel of a vehicle of claim 11,
wherein the connecting body and the transparent housing are formed in a circular shape, and
the coupling portion is set at a position having at least an outer diameter greater than an outer diameter of the front edge of the transparent housing.

14. The non-rotational advertisement member assembly for being mounted on a wheel of a vehicle of claim 13,
wherein a stepped portion having an outer diameter corresponding to the coupling portion is formed at the rear end of the transparent housing corresponding to the coupling portion, and
an ultrasonic welding machine for ultrasonically welding the transparent housing and the connecting body is in contact with the outer surface of the stepped portion.
